(19) United States
(12) Patent Application Publication
(10) Pub. No.: US 2009/0126242 A1
(43) Pub. Date: May 21, 2009

(54) THIN MOTORIZED NOVELTY DEVICE

(75) Inventors: Timothy P. Clegg, Torrance, CA (US); Michael D. Ronk, Torrance, CA (US); Satyajit Deb, Torrance, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: AMERICHIP TECHNOLOGIES, LLC, Torrance, CA (US)

(21) Appl. No.: 12/249,736

(22) Filed: Oct. 10, 2008

Related U.S. Application Data
(63) Continuation-in-part of application No. 12/009,907, filed on Jan. 23, 2008.
Application No. 12/009,907 is a continuation-in-part of application No. 11/986,220, filed on Nov. 20, 2007.

(51) Int. Cl. G09F 11/235; H02P 6/14

(52) U.S. Cl. 40/495; 318/400.42

(57) ABSTRACT

An device including a motor, a disk rotatable by the motor and a housing for the motor and disk, the housing suitable for insertion into a greeting card, magazine, t-shirt, caps, hats, licensed characters, plastic novelty items, sculpted novelty items, figurines, other items of apparels, statutes, models, watches, jewelry, packaging, direct mail, POP displays, gift cards, or in any other type of object in which a moving small eye-catching device having a substantially thin and flat profile might be desired.

This application claims priority from, incorporates by reference and is a continuation in part of co-pending patent application Ser. No. 12/009,907 PCB Rotating Gift Card filed Jan. 23, 2008; and Ser. No. 11/986,220 Motorized Action Card filed Nov. 20, 2007 which are incorporated as though set forth fully herein.

### FIELD OF THE INVENTION

The present invention relates generally to thin motorized devices which may be incorporated into advertising and other promotional materials.

### BACKGROUND OF THE INVENTION

Advertisers often use promotional items to catch potential customers attention. Known techniques may incorporate lights and sounds to grab the attention of the customer. However in some cases the light and/or sound generator is bulky and inappropriate for use with a slimmer promotional item like a magazine, apparel, jewelry or the like which requires an attention grabbing mechanism with a substantially thin and flat profile.

### SUMMARY OF THE PREFERRED EMBODIMENTS

In a preferred embodiment, the present invention is a device including a disk that can spin disposed within a housing that is suitable for insertion into a greeting card, magazine, t-shirt, caps, hats, licensed characters, plastic novelty items, sculpted novelty items, figurines, other items of apparels, statutes, models, watches, jewelry, packaging, direct mail, POP displays, gift cards, or in any other type of object in which a moving small eye-catching device having a substantially thin and flat profile might be desired.

### BRIEF DESCRIPTION OF THE DRAWINGS

The present invention may be more readily understand by referring to the accompanying drawings in which like numerals refer to like parts, and in which:

FIG. 1 is a plan view of the novelty device of one preferred embodiment of the present invention in a circular housing.

FIG. 2 is a cross sectional diagram of a preferred embodiment of the present invention with the top being rectangular and the top of the housing truncated.

FIG. 3 is an exploded view of the disk assembly of a preferred embodiment of the present invention showing a shield ring over the disk which has spokes.

FIG. 4 is a plan view of a printed circuit board used in a preferred embodiment of the present invention mounted in the bottom of a circular housing.

FIG. 5 is a side cross-section of a preferred embodiment of the disk assembly mounted within a clear housing.

FIG. 6 is a plan view of a preferred embodiment of the present invention mounted within a greeting card.

### DETAILED DESCRIPTION OF THE PREFERRED EMBODIMENTS

In the following descriptions of the present invention, terms such as “front,” “back,” “top,” “bottom,” “side,” and the like are used herein merely for ease of description and refer to the orientation of the components as shown in the figures and are not meant to limit the invention.

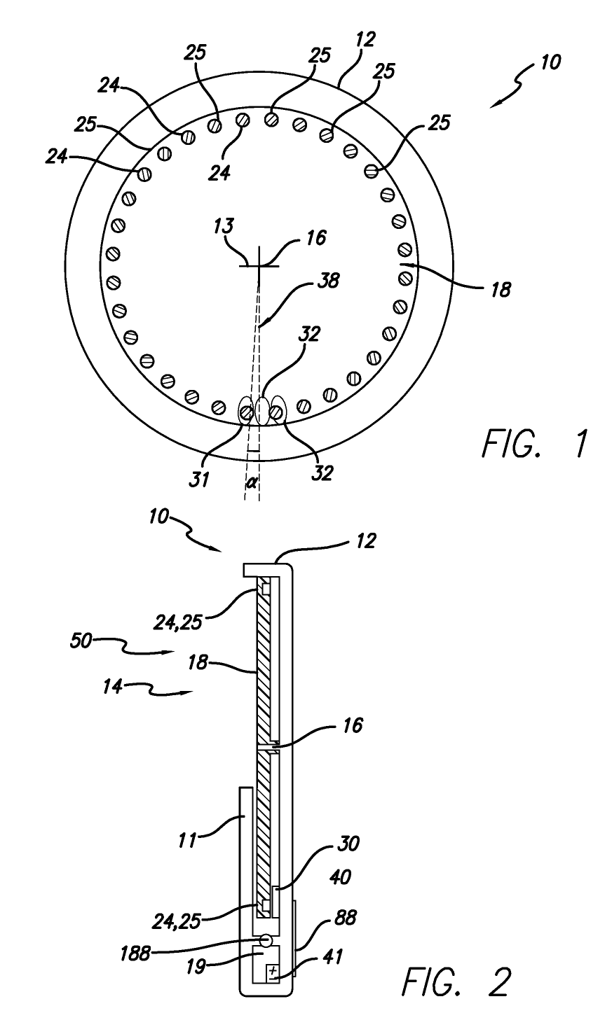

Generally, the present invention may be described as follows. Referring first to FIGS. 1-2, a first preferred embodiment of the invention is shown. A housing 10 having a bottom 12 contains a disk 18 which, in a more preferred embodiment, is circular. However, the disk 18 could be of a wide variety of shapes such as a square, triangle, hexagon or an irregularly shaped object so that in a plan view the disk resembles an egg, tire, flower or other geometrically shaped object. Further, to accommodate an irregular shaped disk, the housing 10 may have a suitable corresponding shape change. The disk 18 is rotatably mounted in the housing 10 preferably at its center 13 by means of an axle 16, which in the preferred embodiment is affixed to the bottom 12. However, in an alternative embodiment, the disk 18 could be mounted to the top of the housing. The housing also may be rectangular or any other shape, and the disk may be mounted not at its center.

In a preferred embodiment, the disk 18 has a plurality of pairs of magnets 24 and 25 mounted substantially along the entire circumference thereof. Each pair of magnets 24 and 25 comprise magnets of opposite polarity which may be mounted on the top, on the bottom, or within the disk 18. In an alternate embodiment, a magnetized ring of metal or other magnetized object could be used instead of the plurality of pairs of magnets.

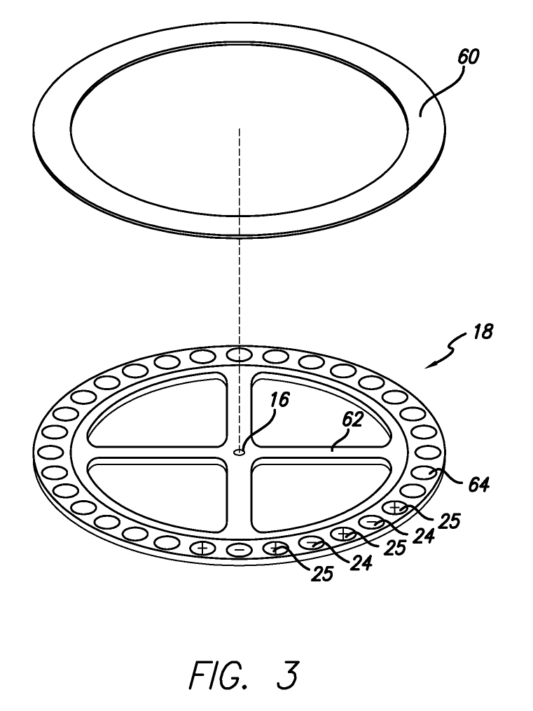

In a preferred embodiment shown in FIG. 3, the disk 18 has a substantially circular shape in which there are a plurality of cutouts 62 such that the interior of the disk resembles spokes on a wheel. This shape provides greater inertia since the majority of the mass of the disk is along its outer perimeter. Regardless of the shape of the disk or housing, the magnets on the disk preferably should be mounted in a substantially circular pattern.

In a preferred embodiment, the disk 18 has a plurality of openings 64 along the outer circumference thereof into which numerous pairs of magnets 24 and 25 are mounted. A metal retaining ring 60 is placed over the magnets to retain the magnets in place and to help shield the magnets from outside electromagnetic interference. The ring 60 also provides further mass for greater inertia and also provides a surface onto which artwork and/or graphics may be adhered.

In a preferred embodiment the disk is approximately 5 mm thick and approximately 50 mm in diameter. In alternate embodiments in print media, it is preferable that the disk is approximately 3.5 mm to approximately 7 mm thick, ranging in diameter from 25 mm to 150 mm. However, in alternate embodiments, the disk can be thinner or thicker or have a smaller or larger diameter with suitable modifications made to the magnets, the housing and means for creating an electromagnetic field so that the disk will still be able to rotate in response to the electromagnetic field.

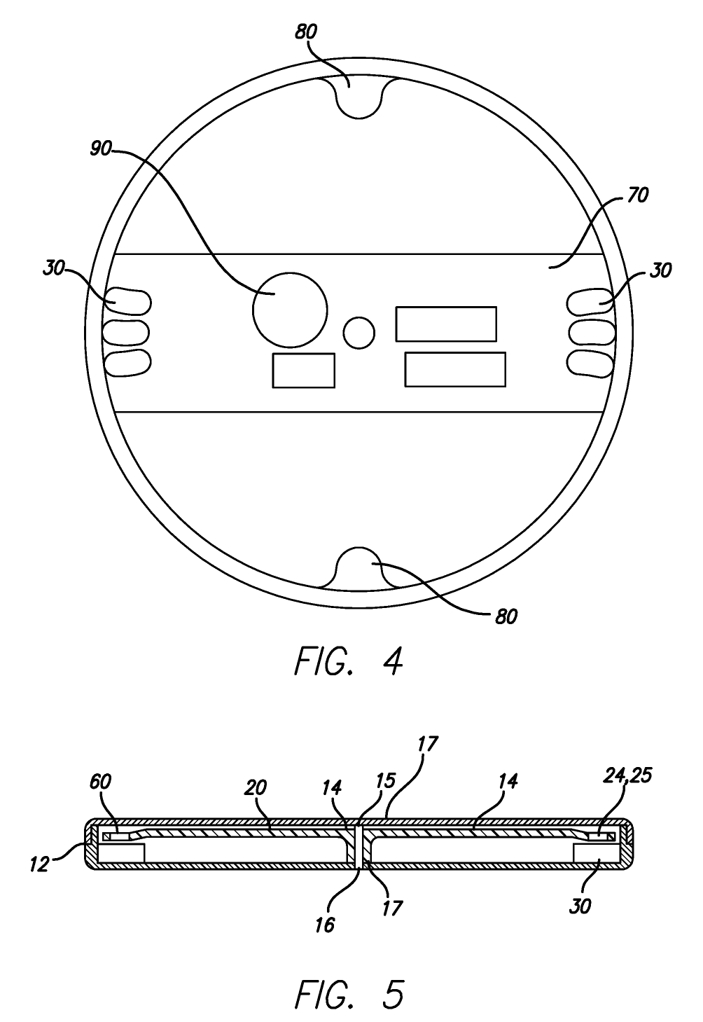

In a preferred embodiment shown in FIG. 4, a circuit board 70 containing a small integrated circuit 90 and a plurality of coils 30 mounted thereon is disposed between the disk 18 and the bottom 12 of the housing 10 so that it does not interfere with the movement of the disk 18 as it rotates. In the preferred embodiment, the housing has insert areas in which the circuit board is mounted as shown in FIG. 4. Each of the coils 30 have three phase construction so that it can rotate the disk 18 by creating an EMF which attracts or repels the magnets 24 and 25. Specifically as each coil is powered on in sequence, it creates an EMF which causes the disk 18 to move in either a clockwise or counterclockwise direction depending on the sequence of which coils are powered on by the integrated circuit. In some embodiments of the present invention, the integrated circuit 90 can power the coils so that the disk 18 will rotate in sequence with music or sound. Alternatively, the disk 18 can move through the use of any other small device that has a low and small profile. The number of coils used are determined by the size of the disk.

The circuit board 70 is connected to a power source 41 which in a preferred embodiment is a set of three small 1.5 mv batteries. The power source can be a battery, a solar panel, a battery module, direct or alternating current from household electric current. However, any power supply having a small profile may be used.

In one embodiment of the present invention, the disk 18 has artwork and/or graphics affixed thereto. In another embodiment of the present invention, the artwork and/or graphics is just affixed to the retaining ring 60. In certain embodiments, such as the one shown in FIG. 5, the housing 10 containing the disk 18 is clear so that any artwork and/or graphics affixed to the disk 18 may be seen. In alternative embodiments, the housing may contain a window 50 through which the artwork and/or graphics could be seen. The window could be in a wide variety of shapes, sizes and/or patterns and could be open or it could be clear. In other embodiments, such as shown in FIG. 2, the top 11 of the housing may be truncated so that a portion of the disk 18 will be exposed.

The present invention can be mounted into, onto or affixed to a greeting card, magazine, t-shirt, caps, hats, licensed characters, plastic novelty items, sculpted novelty items, figurines, other items of apparels, statutes, models, watches, jewelry, packaging, direct mail, POP displays, gift cards, or in any other type of object in which a moving small eye-catching device having a substantially flat profile might be desired.

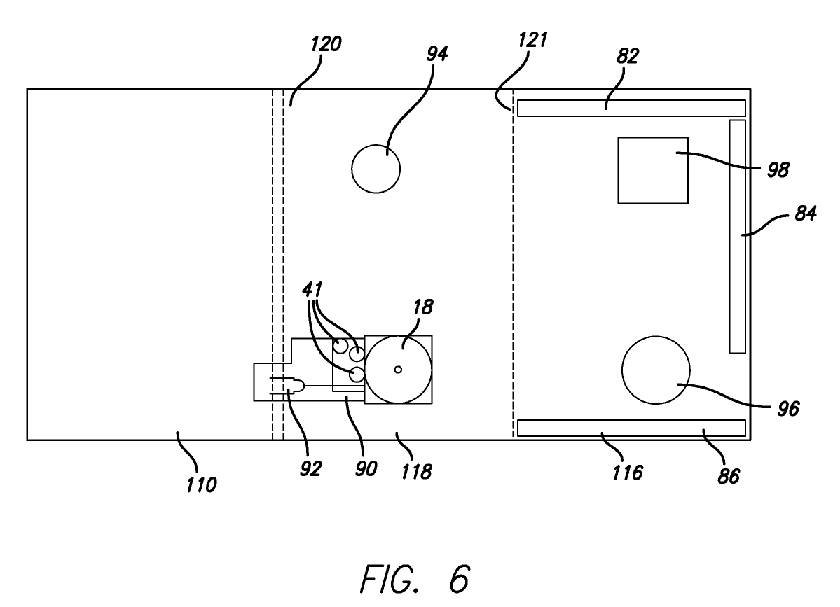

One such embodiment is mounted into a greeting card or print advertising piece as shown in FIG. 6. Specifically, in FIG. 6, after the disk module 90 is assembled into the housing 10, it is placed onto a greeting card. The interior of the greeting card is preferably formed between a second page top sheet 116 and a second page bottom sheet 118. In the embodiment shown in FIG. 6, the second page top sheet 116 folds over the second page bottom sheet 118 sandwiching the disk module 90 and a switch 92. The switch can be a slide switch, a pushbutton, a toggle switch, a light sensor, a touch sensor, a voice sensor, vibration sensor, airflow sensor, or a momentary switch. In addition, other electronics 94 may be enclosed for the playback of a message, music or the like or for the creating of another visual effect such as a light. A secondary folding line 121 folds once for enclosing the disk module piece and other electronics, if any. The second page top sheet receives a double-sided top tape strip 82, a double-sided side tape strip 84, and a double-sided bottom tape strip 86 to permanently seal the second page top sheet 116 to the second page bottom sheet 118. However, any means known in the art may be used to adhere the top sheet 116 to the bottom sheet 118.

The disk module 90 includes the battery or power module 41 and the slide switch 92. In a preferred embodiment, the slide switch 92 shares the same base as the disk module 90 and the battery module 41. The same base allows for a single motion placement of the elements on the print piece. In a preferred embodiment, the slide switch 92 extends from the disk module 90 such that when a user opens the greeting card so that the first page extends away from the disk module 90, the slide switch 92 will be released, thereby closing the circuit. Regardless of the type of switch used, when the circuit is closed, the battery power energizes the integrated circuit in the disk module which in turn energizes the coils 30 such that the disk will begin to spin in response thereto. In addition, in a preferred embodiment, the closing of the circuit also energizes the additional electronics such that a message may be played back and/or LED lights can also be activated.

In the embodiment shown in FIG. 6, the top of the second page 116 contains a window 96 which may either be a cutout in the card or be a cutout covered with a transparent covering such as a glassine envelope type covering so that the artwork and/or graphics on the disk may be seen. Similarly, the speaker may have an aperture window on the second page top sheet for unimpeded sound. The speaker may also be adorned or accompanied by LED lights also possibly flashing through the speaker aperture window in synchronization with a theme of a prerecorded recording.

Instead of slide switch activation, the disk could be activated by a pushbutton mounted on the disk module. The pushbutton activation is preferable when users want to control activation of the rotation. Also, the pushbutton could be used in conjunction with the slide switch and is not necessarily mutually exclusive.

The embodiments and methods described above are exemplary embodiments and methods of the present invention. While particular embodiments of the present invention have been illustrated and described, it will be apparent that various modifications can be made without departing from the spirit and scope of the invention. Those skilled in the art may now make various uses of, and departures from, the above-described embodiments and methods without departing from the inventive concepts disclosed herein. Thus, the construction of the embodiments and the steps of the methods disclosed herein are not limitations of the present invention. Accordingly, the present invention is to be defined solely by the scope of the following claims.

1. A motorized novelty item comprising:
a housing having a top and a bottom;
an axle mounted within the housing;
a disk mounted for free rotation on the axle, the disk having a magnetic potential which interacts with a electromagnetic field disposed proximate to the disk;
means for creating the electromagnetic field mounted within the housing; a integrated circuit for sending signals to the means for creating the electromagnetic field;
a power source for powering the electromagnetic field and the processor; whereby when the electromagnetic field is created, the disk will rotate, and a least a portion of the disk will be visible from outside the housing.

2. The novelty item of claim 1 further comprising means for playing an audio recording whereby the integrated circuit causes the disk to rotate in synch with the audio recording.

3. The novelty item of claim 1 further comprising graphics affixed to the visible portion of the disk.

4. The novelty item of claim 1 further comprising a light source, whereby the integrated circuit causes the disk to rotate and the lights to go on and off in synch.

5. The novelty item of claim 1 wherein said disk is of any geometrical shape.

6. The novelty item of claim 1 wherein at least the top of the housing containing the disk is clear so that the top of the disk may be seen.

7. The novelty item of claim 1 wherein the housing containing the disk has a window through which the disk may be seen.

8. The novelty item of claim 1 wherein at least the top of the housing containing the disk is clear so that any artwork and/or graphics affixed to the disk may be seen.

9. The novelty item of claim 1 wherein said means for creating the electromagnetic field comprises a plurality of coils.

10. An novelty device comprising:
a thin motor housing containing an axle therein;
a disk mounted for free rotation on the axle, the disk having a magnetic potential which interacts with an electromagnetic field disposed proximate to the disk within the motor housing;
coils for creating the electromagnetic field which turns the disk mounted proximate the disk so that they will cause the disk to move when the electromagnetic field is created, and
a power source for powering the coils.

11. The device of claim 10 further comprising an integrated circuit for sending signals to the means for creating the electromagnetic field, and means for playing an audio recording, whereby the integrated circuit causes the disk to rotate in synch with the audio recording.

12. The device of claim 10 further comprising an integrated circuit for sending signals to the means for creating the electromagnetic field, and a light source, whereby the integrated circuit causes the disk to rotate and the lights to go on and off in synch.

13. The novelty item of claim 10 wherein said disk is of any geometrical shape.

14. The novelty item of claim 10 wherein at least the top of the housing containing the disk is clear so that the top of the disk may be seen.

15. The novelty item of claim 10 wherein the housing containing the disk has a window through which the disk may be seen.

16. The novelty item of claim 10 wherein at least the top of the housing containing the disk is clear truncated so that any artwork and/or graphics affixed to the disk may be seen.

17. The novelty item of claim 10 wherein said means for creating the electromagnetic field comprises a plurality of coils.

18. A print piece comprising:
a print piece;
a disk housing, the disk housing comprising:
a disk mounted for free rotation on an axis within the housing, wherein the disk comprises means for creating a magnetic field which interacts with an electromagnetic field created within the housing;
means for creating the electromagnetic field;
a switch;
a power source powering the electromagnetic field means when the switch is activated, whereby when the electromagnetic field is created, the disk will rotate.

19. The print piece of claim 18 wherein said housing further comprising a integrated circuit for sending signals to the means for creating the electromagnetic field, and means for playing an audio recording, whereby the integrated circuit causes the disk to rotate in synch with the audio recording.

20. The print piece of claim 18 further comprising a integrated circuit for sending signals to the means for creating the electromagnetic field, and a light source, whereby the integrated circuit causes the disk to rotate and the lights to go on and off in synch.

21. A method of promotion, the method comprising the following steps:
a. providing a magnetized disk, the disk having graphics thereon;
b. providing an electromagnetic field proximate the disk;
c. housing the disk and the electromagnetic field providing means in a housing substantially conforming to the shape of the disk; and
d. selecting a promotional item from the group consisting of a greeting card, magazine, t-shirt, cap, hat, direct mail, cardboard, gift card, print collateral or packaging; and e. incorporating the housing in the promotional item so when the disk rotates, the graphics can be seen.
